(19) United States
(12) Patent Application Publication
(10) Pub. No.: US 2017/0179792 A1
(43) Pub. Date: Jun. 22, 2017

(54) ENCLOSED MOTOR UTILIZING RECIRCULATING COOLANT AIR

(71) Applicant: Nidec Motor Corporation, St. Louis, MO (US)

(72) Inventors: Peter F. Gowans, Verona, NY (US); Timothy H. Sullivan, Camillus, NY (US); Michael Coles, Manlius, NY (US)

(73) Assignee: Nidec Motor Corporation, St. Louis, MO (US)

(21) Appl. No.: 15/387,223

(22) Filed: Dec. 21, 2016

Related U.S. Application Data
(60) Provisional application No. 62/270,464, filed on Dec. 21, 2015.

(51) Int. Cl. H02K 9/06; H02K 1/26; H02K 13/00; H02K 23/00; H02K 5/20; H02K 1/14

(52) U.S. Cl. CPC H02K 9/06; H02K 5/20; H02K 1/14; H02K 13/006; H02K 23/00; H02K 1/26; H02K 2213/03

(57) ABSTRACT

An electric motor includes a housing, a rotor rotatable about an axis, a stator including a core and a plurality of coils wound about the core, a commutator, and a fluid-driving element configured to drive a fluid. The housing defines an internal chamber including a stator-receiving space at least substantially receiving the stator, a commutator-receiving space at least substantially receiving the commutator, and an element-receiving space at least substantially receiving the fluid-driving element. The housing further defines a cooling pathway fluidly interconnected with the internal motor chamber and disposed at least in part radially outside the stator. The fluid-driving element and the housing are cooperatively configured to direct the fluid through each of the stator-receiving space, the commutator-receiving space, the element-receiving space, and the cooling pathway.

### RELATED APPLICATION

The present application claims the benefit of U.S. Provisional Application Ser. No. 62/270,464, filed Dec. 21, 2015, entitled ENCLOSED MOTOR UTILIZING RECIRCULATING COOLANT AIR, which is hereby incorporated in its entirety by reference herein.

### 1. FIELD OF THE INVENTION

The present invention relates generally to an electric motor. More particularly, the present invention relates generally to an enclosed electric motor.

### 2. DISCUSSION OF THE PRIOR ART

An enclosed motor construction is desirable in a variety of different applications, including those in which the surrounding environment could damage the components of the motor. Such an environment might be abnormally hot or cold, have a high moisture content (e.g., highly humid or fully marine), or include abnormal amounts of particulate such as dirt or dust.

Wind turbines are often operated in generally harsh environments exposed to the elements (e.g., rain, snow, and wind). Furthermore, horizontal-axis wind turbines often require pitch motors to rotatably adjust the orientations of individual blades of the rotor about the longitudinal axis of the given blade to best “catch” or deflect wind as desired. For instance, pitch motors might be used to set each blade at an optimum angle to efficiently produce rotation of the rotor. Such motors are preferably enclosed motors to enable operation in the aforementioned harsh environment.

Enclosed motor constructions may suffer from problems associated with dispersal and removal of thermal energy generated by the motor. Furthermore, such problems may result in motor performance limitations. That is, the thermal limit of the motor may cap or limit the performance of the motor. Thus, effective cooling of a given motor may increase its performance ceiling, enabling greater performance before the thermal limit is reached.

A variety of motor cooling approaches are known in the art. For instance, heat sinks might be provided to conduct heat away from the motor, an internal fan might agitate air within the motor chamber, and/or external air might be directed to the outside of the motor housing to remove heat via convection. Furthermore, in the case of induction motors, the field coil size might be maximized to increase conductive thermal transfer to the motor housing or frame.

### SUMMARY

The following brief summary is provided to indicate the nature of the subject matter disclosed herein. While certain aspects of the present invention are described below, the summary is not intended to limit the scope of the present invention.

An electric motor assembly comprises a housing, a rotor rotatable about an axis, a stator including a core and a plurality of coils wound about the core, a commutator, and a fluid-driving element configured to drive a fluid. The housing defines an internal chamber including a stator-receiving space at least substantially receiving the stator, a commutator-receiving space at least substantially receiving the commutator, and an element-receiving space at least substantially receiving the fluid-driving element. The housing further defines a cooling pathway fluidly interconnected with the internal motor chamber and disposed at least in part radially outside the stator. The fluid-driving element and the housing are cooperatively configured to direct the fluid through each of the stator-receiving space, the commutator-receiving space, the element-receiving space, and the cooling pathway.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is side perspective view from a forward perspective of an electric motor assembly constructed in accordance with a preferred embodiment of the present invention;

FIG. 2 is a partially exploded, partially sectioned side perspective view from a rearward perspective of the electric motor assembly of FIG. 1, particularly illustrating external cooling flowpaths;

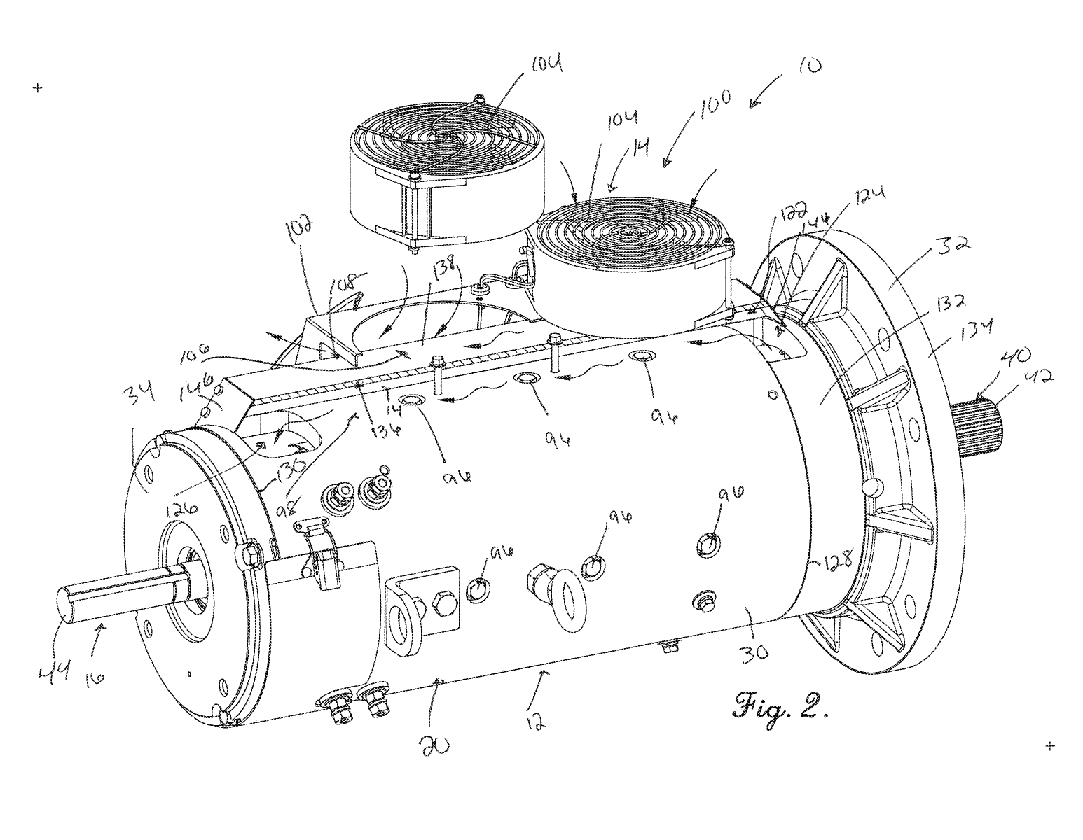

FIG. 3 is a partially sectioned side perspective view from a forward perspective of the electric motor assembly of FIGS. 1 and 2, particularly illustrating internal and external cooling flowpaths;

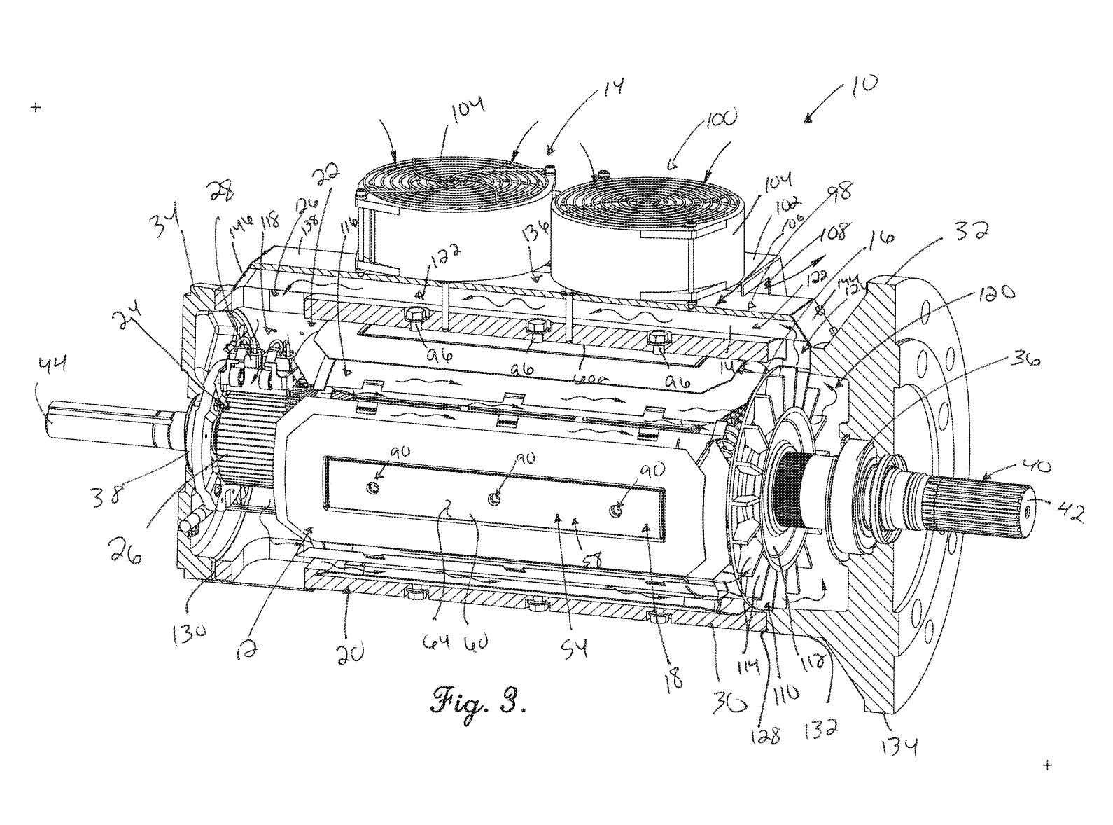

FIG. 4 is a partially sectioned side perspective view from a rearward perspective of the electric motor assembly of FIGS. 1-3, particularly illustrating internal and external cooling flowpaths;

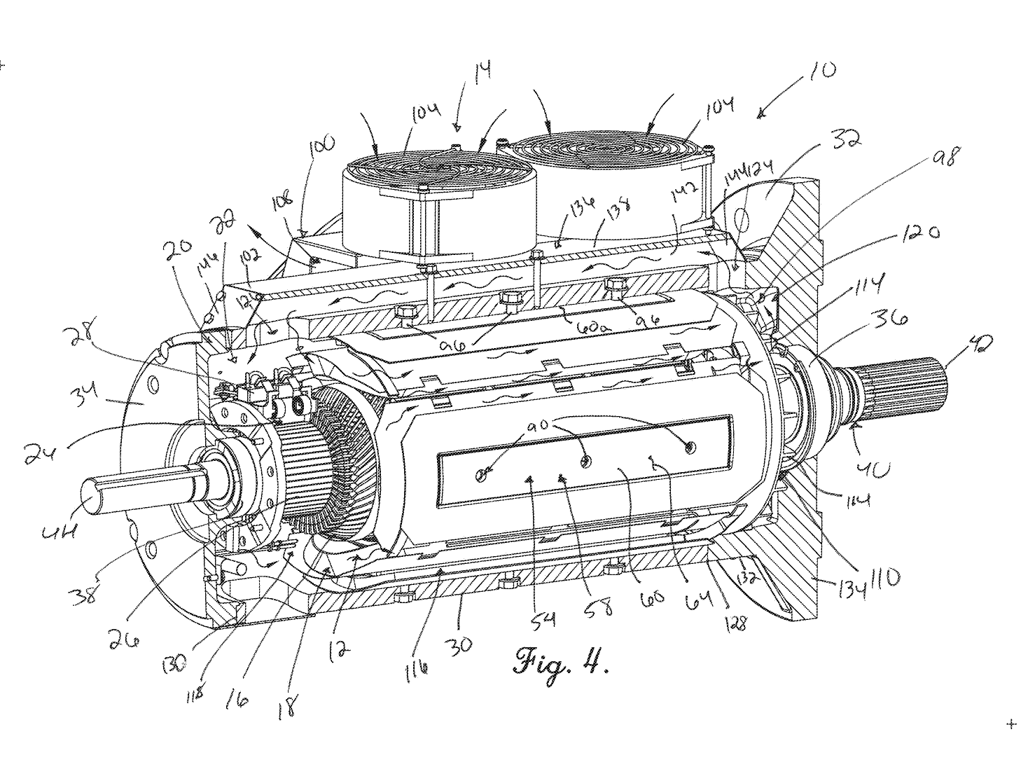

FIG. 5 is a partially exploded rear perspective view of a portion of the motor assembly of FIGS. 1-4, with the rotor and other features removed for clarity, and particularly illustrating the design of the stator and the motor housing;

FIG. 6 is a partially sectioned rear view of the motor assembly of FIGS. 1-5, with the rotor and other features removed for clarity, and particularly illustrating the internal and external cooling flowpaths and their relation to the stator coils;

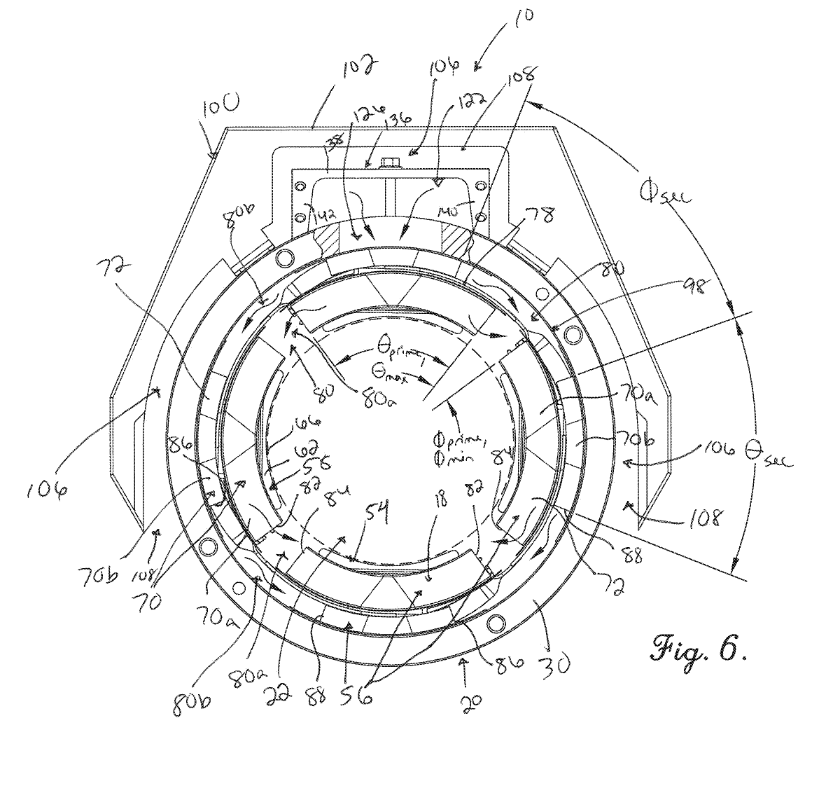

FIG. 7 is a rear view of the motor assembly of FIGS. 1-6, with the shroud removed;

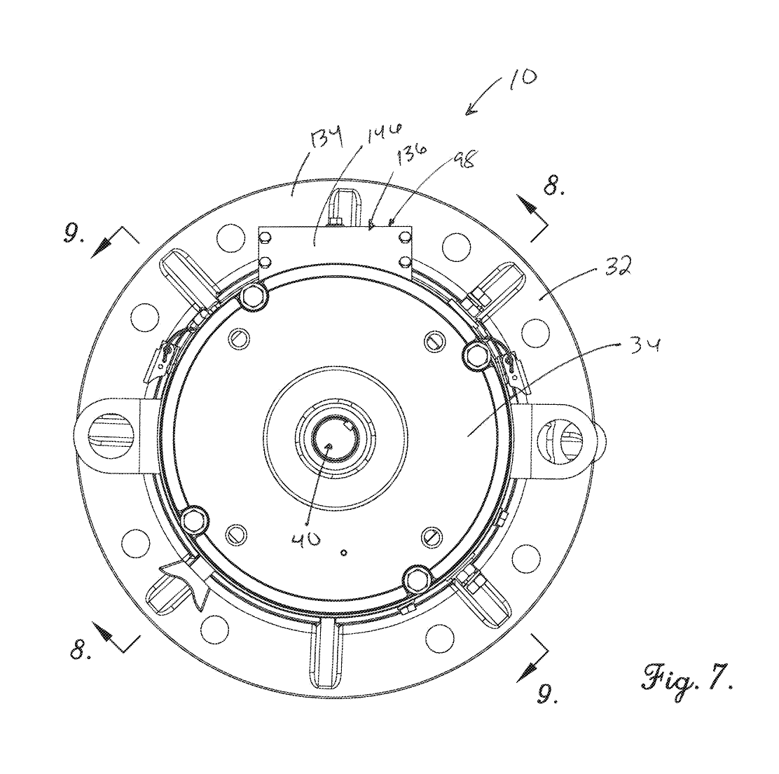

FIG. 8 is a partially sectioned side view taken along line 8-8 of FIG. 7, particularly illustrating a first pair of each of the primary and secondary internal channels; and

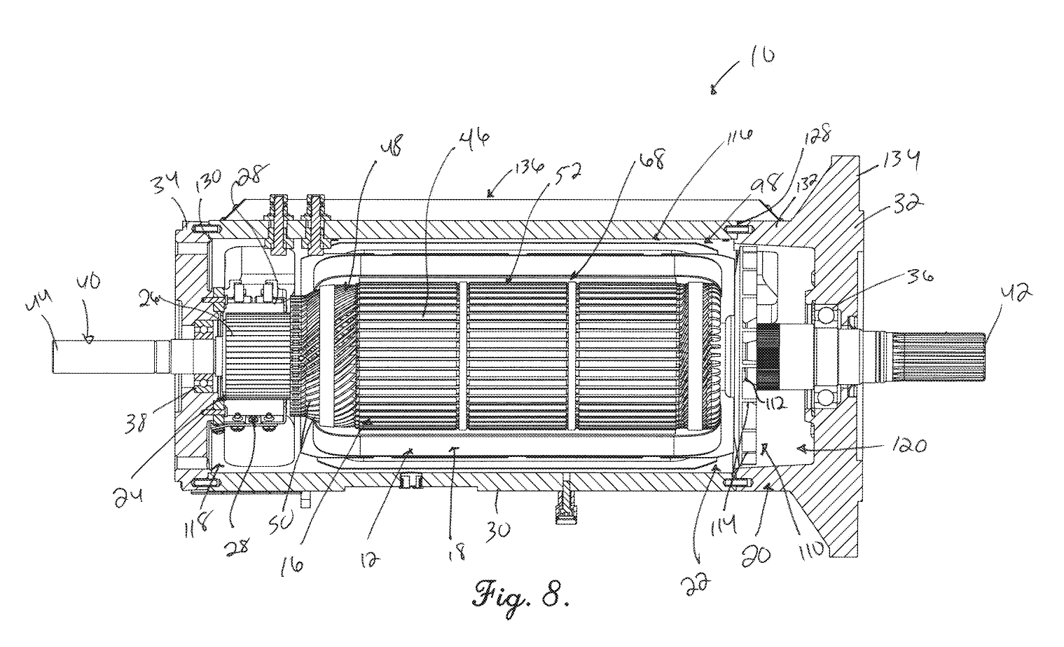

FIG. 9 is a partially sectioned side view taken along line 9-9 of FIG. 7, particularly illustrating a second pair of each of the primary and secondary the internal channels.

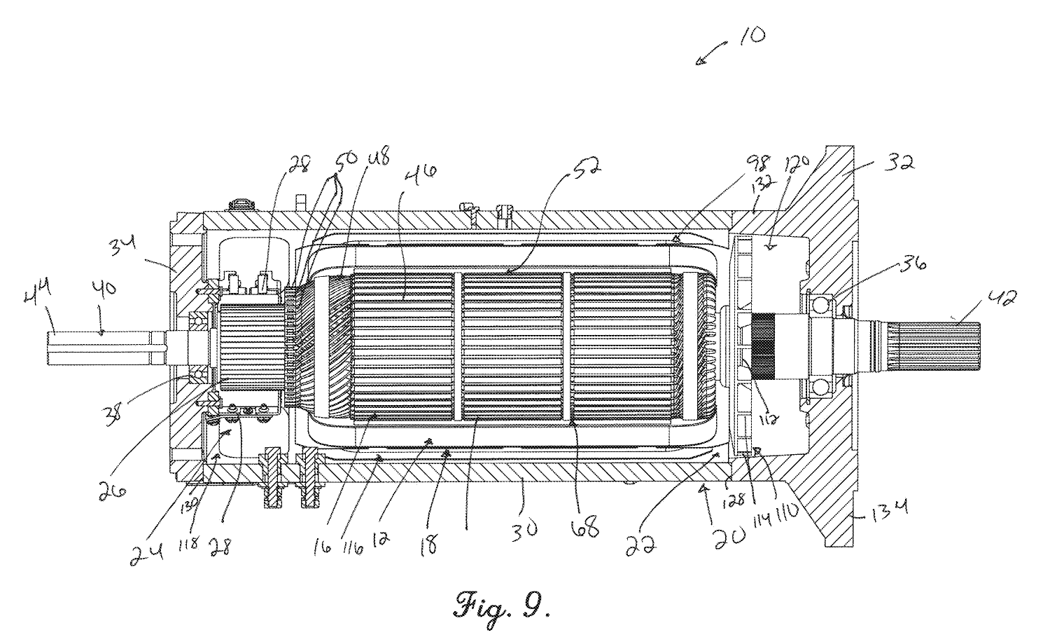

The drawing figures do not limit the present invention to the specific embodiments disclosed and described herein. The drawings are not necessarily to scale, emphasis instead being placed upon clearly illustrating the principles of the preferred embodiment.

Furthermore, directional references (e.g., top, bottom, front, back, side, etc.) are used herein solely for the sake of convenience and should be understood only in relation to each other unless otherwise made clear. For instance, a component might in practice be oriented such that faces referred to as “top” and “bottom” are sideways, angled, inverted, etc. relative to the chosen frame of reference. Similarly, terms such as “proximal” and “distal” should be understood in a relative sense.

Yet further, locational descriptions such as “radially inner,” “radially outer,” etc. should not be construed as limiting the subject structure to a circular form unless otherwise specified.

### DETAILED DESCRIPTION OF THE PREFERRED EMBODIMENTS

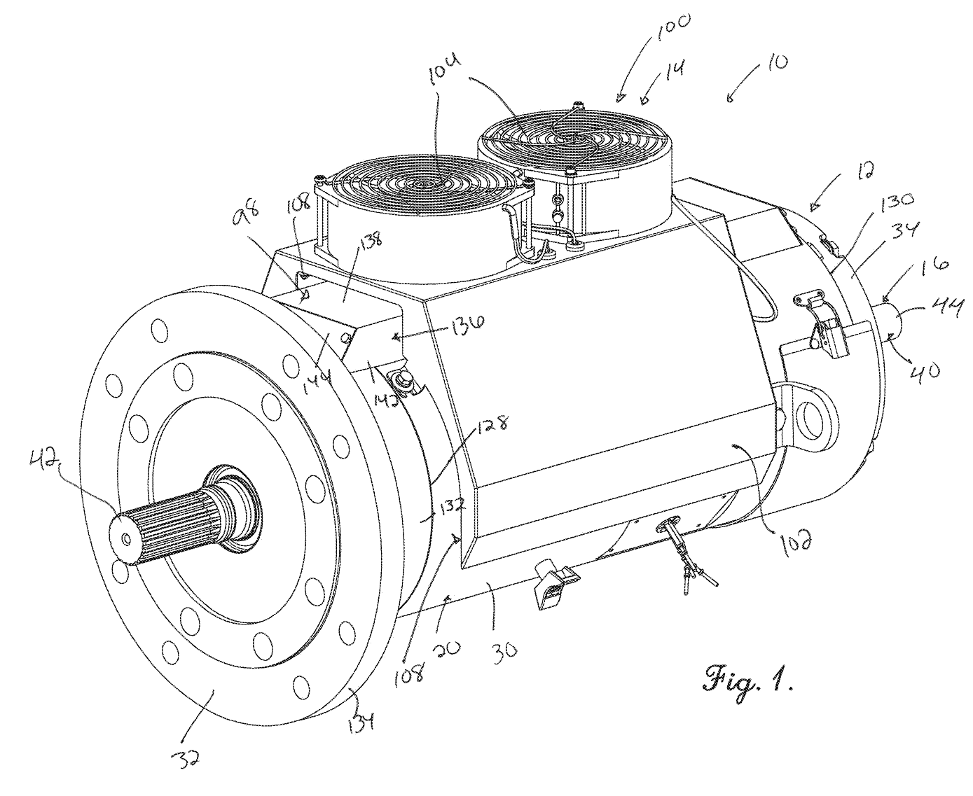

FIG. 1 illustrates a motor assembly 10 in accordance with a preferred embodiment of the present invention. The motor assembly 10 includes a motor 12 and an external fan assembly 14.

In a preferred embodiment, as will be apparent from the description below, the motor 10 is a brushed or commutated series-wound DC (direct current) motor. However, the motor may alternatively be a brushless DC motor or an AC (alternating current) motor such as an induction motor or synchronous motor without departing from some aspects of the present invention. Furthermore, any one or more of a variety of brushed DC motor types, including but not limited to shunt wound, separately excited, series wound (as preferred), compound wound, permanent magnet, servomotor, and universal, may fall within the scope of some aspects of the present invention.

The motor 12 preferably broadly includes a rotor 16 rotatable about an axis, a stator 18, and a housing or frame 18. As will be discussed in greater detail below, the housing 20 preferably defines an interior chamber 22 that at least substantially receives the rotor 16 and the stator 18. The motor 12 further preferably includes a commutator assembly 24 including a commutator 26 and a pair of brush assemblies 28.

The housing 20 preferably includes a generally cylindrical shell 30, a drive-end endshield 32, and a commutator-end endshield 34. Each endshield 32 and 34 preferably supports a corresponding bearing 36 or 38. The bearings 36 and 38 cooperatively rotatably support the rotor 16 on the endshields 32 and 34.

The housing 20 is preferably at least substantially closed. That is, the shell 30 and the endshields 32 and 34 are preferably devoid or at least substantially devoid of slots or other openings associated with ventilation or non-integral functions. Any openings that do extend through the housing 20 are preferably sealed or at least substantially obstructed (e.g., by a fastener extending therethrough) such that transfer of fluids (e.g., air) or contaminants (e.g., dust or grease) through the opening is fully or largely restricted.

The rotor 16 preferably includes a shaft 40 rotatable about an axis. The shaft 40 preferably presents a drive end 42 and a commutator end 44. The rotor 16 further preferably includes a rotor core 46 and an armature winding 48 including a plurality of armature coils 50 wound about the rotor core 46. The rotor core 46 also preferably defines a radially outermost margin 52 of the rotor core 46.

The rotor 16 is preferably a wound rotor, as illustrated, but could alternatively be of another type (e.g., a “squirrel cage” rotor).

The stator 18 preferably includes a stator core 54 and a field winding 56. More particularly, the stator core 54 preferably includes a plurality of pole pieces or teeth 58. Preferably, each pole piece 58 includes a generally arcuately extending base 60; a generally straight, generally radially extending leg (not shown) extending from the base 60; and a crown 62 extending generally arcuately from the leg opposite the base 60. In a preferred embodiment, the base 60 and the leg are similarly shaped and dimensioned such that the base 60 and the leg are indistinguishable from one another.

In a preferred embodiment, the bases 60 cooperatively present a radially outermost circumferential margin 64 of the stator core 54. The crowns 62 preferably cooperatively present a radially innermost circumferential margin 66 of the stator core 54.

Preferably the stator 18 circumscribes or at least substantially circumscribes the rotor 16, such that the innermost margin 66 of the stator core 54 is spaced from the outermost margin 52 of the rotor core 46 by a generally circumferentially extending gap 68.

The field winding 56 preferably includes a plurality of field coils 70, each comprising electrical conductive wiring 72 wound about the stator core 54. The field coils 70 include a radially inner set of primary field coils 70a and a radially outer set of secondary field coils 70b arranged concentrically with the primary field coils 70a.

In a preferred embodiment, the primary field coils 70a are utilized during normal operation of the motor 12. The secondary field coils 70b are utilized for battery and/or automatic shutdown. Both sets of field coils 70a and 70b may also be used simultaneously in some circumstances.

It is permissible according to some aspects of the present invention for more sets of coils to be provided or for only a single set to be provided. Yet further, the coils might be alternatively configured for operation (e.g., directional, multi-speed, start or auxiliary, main, etc.). Still further, the winding might form multiple coil layers associated with a single set. For instance, multiple radially stacked coils might be part of a set of primary field coils. Further still, the primary field coils might be disposed radially outside the secondary field coils or be alternately arranged therewith (e.g., non-concentrically). In summary, as will be apparent to one of ordinary skill in the art, any of a wide range of coil configurations are permissible according to some aspects of the present invention.

In a preferred embodiment, a primary field coil 70a and a secondary field coil 70b are wound about each pole piece 58. Furthermore, the pole pieces 58 and, in turn, the field coils 70 are preferably arcuately arranged. More particularly, the pole pieces 58 and the field coils 70 are preferably evenly arcuately arranged. However, it is permissible according to some aspects of the present invention for alternate winding configurations and/or spacings to be implemented. For instance, the primary and/or secondary field coils might span more than one pole piece, and/or the primary and secondary field coils might be arcuately offset from one another.

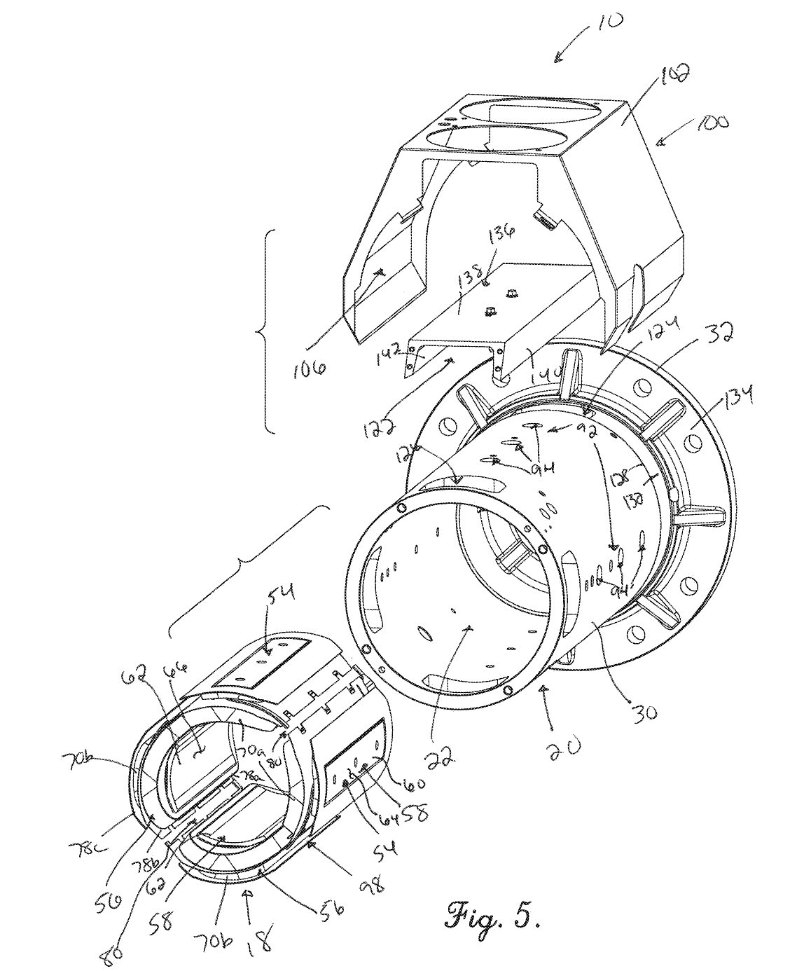

In a preferred embodiment, insulation is provided radially inside the primary field coils 70a, between radially stacked primary and secondary field coils 70a and 70b, and between the secondary field coils 70b and the shell 30 (i.e., radially outside the secondary field coils 70b). As shown in FIG. 5 and others, for instance, a bobbin 78 including tiers 78a,b,c, is disposed on each pole piece 58. Each of the coils 70a and 70b are wound about a respective one of the bobbins 78.

Preferably, the bobbins 78 comprise an electrically insulative or at least substantially electrically insulative material such as a synthetic resin. Furthermore, although the illustrated bobbin-based approach to insulation is preferred, additional or alternative means, including but not limited to overmolding, wire coating, tabs, papers, and the like, may be used without departing from the scope of some aspects of the present invention.

In a preferred embodiment, internal channels 80 are cooperatively preferably defined between adjacent ones of the field coils 70. That is, each primary field coil 70a preferably presents a pair of generally arcuately opposed sides 82 and 84. Sides 82 and 84 of adjacent primary field coils 70a are preferably arcuately spaced from each other so as to define a generally axially and arcuately extending primary internal channel 80a therebetween. Similarly, each secondary field coil 70b preferably presents a pair of generally arcuately opposed sides 86 and 88. Sides 86 and 88 of adjacent secondary field coils 70b are preferably arcuately spaced from each other so as to define a generally axially and arcuately extending secondary internal channel 80b therebetween. Corresponding primary and secondary internal channels 80a and 80b cooperatively form at least part of (and most preferably define in their entirety) each of the more broadly defined internal channels 80. The function of the internal channels 80 will be discussed in greater detail below.

In the illustrated embodiment, bobbins 78 project at least in part into the internal channels 80, although such a configuration is not necessary according to some aspects of the present invention.

Preferably, four (4) pole pieces 58, four (4) primary field coils 70a, and four (4) secondary field coils 70b are provided, such that four (4) internal channels 80 (including four (4) primary internal channels 80a and four (4) secondary internal channels 80b) are provided. More or fewer pole pieces, field coils, and channels may be present without departing from the scope of some aspects of the present invention, however.

As will be readily apparent to those of ordinary skill in the art, management of heat associated with motor operation is often a critical consideration in motor design. So-called “closed” motors such as the motor 12 are particularly prone to overheating if sufficient means of removing or redirecting heat are not provided, as are brushed motors such as the motor 12. Thus, preferred embodiments of the present invention include several means of removing heat from the motor 12.

For instance, in a preferred embodiment, as illustrated, the motor 12 preferably includes both conductive and convective cooling means. With regards to conductive means, for instance, the pole pieces 58 of the stator 18 preferably directly abut and transfer heat to the motor shell 30. More particularly, each base 60 preferably defines three (3) fastener-receiving holes 90. The shell 30 preferably presents four (4) sets 92 of three (3) fastener-receiving apertures 94, with each set 92 corresponding to one of the pole pieces 58 and with the apertures 94 of a given set 92 corresponding to the fastener-receiving holes 90 of the associated pole piece 58. Fasteners 96, preferably but not necessarily in the form of bolts, extend through corresponding pairs of apertures 94 and fastener-receiving holes 90 to fix the bases 60 (and, in turn, the pole pieces 58) to the shell 30. Conductive transfer of thermal energy (i.e., heat) from the pole pieces 58 to the shell 30 may thus occur through an interface 60a between each base 60 and the shell 30.

Preferably, the bases 60 and the shell 30 are complimentary in shape so as to provide engagement therebetween along the entirety of the bases 60. However, non-optimized shapes are permissible according to some aspects of the present invention. For instance, adjoining faces of the bases and shell might have a different radii of curvature.

In addition to the above-described conductive cooling means, other conductive means of cooling, including fins or other heat sinks, may also be provided.

Still further, in a preferred embodiment, both a primary convective cooling system 98 and a secondary convective cooling system 100 are provided. The secondary convective cooling system 100 comprises the external fan assembly 14, including a shroud 102 and a pair of external fans 104 mounted to the shroud 102. The shroud 102 is preferably secured exteriorly to the motor housing 20 (more particularly, to the shell 30) such that the shroud 102 in part encircles or encompasses the shell 30. Preferably, the shroud 102 is sized in shaped in such a manner as to define a cooling space 106 about the shell 30 (i.e., between the shell 30 and the shroud 102). The fans 104 preferably direct air from the environment into the cooling space 106 and along the shell 30 to remove heat from the shell 30. The heated air is then dispersed to the environment upon exiting the cooling space through gaps 108 between the shell 30 and the shroud 102.

Preferably, the shroud 102 and, in turn, the cooling space 106 encircle at least twenty-five percent (25%) of the shell 30. More preferably, the shroud 102 and the cooling space 106 encircle at least about fifty percent (50%) of the shell. Most preferably, the shroud 102 and the cooling space 106 encircle about sixty-two and five tenths percent (62.5%) of the shell 30.

It is permissible according to some aspects of the present invention for the external cooling assembly to be omitted entirely or alternatively configured, however. With regard to alternative configurations, for instance, more or fewer fans might be provided, or the shroud might extend around the entirety of the shell. Furthermore, the shroud might be fixed to the endshields or other housing components rather than to the shell.

In a preferred embodiment, and as will be discussed in greater detail below, the primary convective cooling system 98 is configured to forcibly recirculate a fluid through the interior chamber 22. For instance, in a preferred embodiment, the motor 12 includes a fluid-driving element 110 configured to drive the fluid. The fluid-driving element 110 is preferably fixed to the motor shaft 40 to rotate therewith, although alternative mounting and/or drive sourcing is permissible according to some aspects of the present invention.

The fluid is preferably a gas and is most preferably air, although other gases or even liquids may be permissibly utilized without departing from the scope of some aspects of the present invention.

In a preferred embodiment, as illustrated, the fluid-driving element 110 is a fan. The fan 110 preferably includes a hub 112 fixed to the shaft 40 to rotate therewith. The fan 110 further preferably includes a plurality of arcuately spaced apart, generally radially extending blades 114.

Preferably, the fan 110 is configured to draw air thereinto in a generally axial direction and force air therefrom in a generally radial direction. That is, the fan 110 is preferably a centrifugal fan or blower fan. However, it is permissible according to some aspects of the present invention for the fan to alternatively be an axial fan that draws air in and forces air out in an axial direction. Another type of fluid-driving element (e.g., bellows, etc.) might also be used without departing from the scope of some aspects of the present invention.

Preferably, the interior chamber 22 includes a stator-receiving space 116 at least substantially receiving the stator 18, a commutator-receiving space 118 at least substantially receiving the commutator 26, and an element-receiving space 120 at least substantially receiving the fluid-driving element 110. The spaces 116, 118, and 120 are preferably fluidly interconnected. Furthermore, the commutator-receiving space 118 and the element-receiving space 120 are preferably disposed at axially opposite ends of the stator-receiving space 116.

Thus, the fan 110 is preferably disposed axially opposite the commutator assembly 24. Furthermore, the rotor 16 (with the exception of the ends 42 and 44 of the shaft 40) and the stator 18 are thereby disposed (or at least substantially disposed) axially between the commutator assembly 24 and the fan 110.

The housing 20 further preferably defines a cooling pathway 122 fluidly interconnected with the interior chamber 22 and disposed at least in part radially outside the stator 18. The fluid-driving element 110 and the housing 20 are cooperatively configured to direct fluid through each of said stator-receiving space 116, the commutator-receiving space 118, the element-receiving space 120, and the cooling pathway 122.

More particularly, in preferred embodiment, the housing 20 defines a pathway inlet 124 and a pathway outlet 126 fluidly interconnected with and by the cooling pathway 122. The pathway inlet 124 is also directly fluidly interconnected with the element-receiving space 120. Furthermore, the pathway outlet 126 is directly fluidly interconnected with the commutator-receiving space 118.

It is noted that the pathway inlet 124 may alternately be viewed as an outlet from the interior chamber 22 or, more particularly, from the element-receiving space 120. Similarly, the pathway outlet 126 may alternately be viewed as an inlet into the interior chamber 122 or, more particularly, into the commutator-receiving space 118.

The drive-end endshield 32 and the shell 30 preferably engage one another along a drive-end interface 128. The commutator-end endshield 34 and the shell 30 preferably engage one another along a commutator-end interface 130. The pathway inlet 124 is preferably defined immediately adjacent the drive-end interface 128. In greater detail still, the drive-end endshield 32 preferably includes a generally cylindrical, axially extending tube portion 132 and a radially outwardly extending flange 134 extending from the tube portion 132. The tube portion 132 preferably presents an at least substantially similar cross-section to that of the shell 30 and engages the shell 30 along the drive-end interface 128. A notch extends from the drive-end interface 128 into the tube portion 132 to define the pathway inlet 124. In contrast, in a preferred embodiment, the outlet 126 is in the form of an opening defined solely by the shell 30 near the commutator-end interface 130. Alternative positioning and/or definition of the pathway inlet and pathway outlet is permissible according to some aspects of the present invention. It is also permissible according to some aspects of the present invention for multiple pathway inlets and/or outlets to be provided.

Preferably, as noted above, the pathway inlet 124 and the pathway outlet 126 are fluidly interconnected by the cooling pathway 122. In the preferred illustrated embodiment, a shield 136 is secured to the housing 20 to cooperate with the housing 20 to define the cooling pathway 122. More particularly, the shield 136 preferably includes a roof 138 spaced generally radially from the shell 30, a pair of longitudinally extending sidewalls 140 and 142 extending between the inlet 124 and the outlet 126, and a pair of axially spaced apart end walls 144 and 146. The end walls 144 and 146 are disposed at respective outermost margins of the inlet 124 and outlet 126 and extend between and interconnect the sidewalls 140 and 142. The roof 138, in turn, connects the sidewalls 140 and 142 and end walls 144 and 146 to one another. The shield 136, the shell 30, and the tube portion 132 (at or adjacent the inlet 124) cooperatively define an interior space that defines the cooling pathway 122.

Thus, in a preferred embodiment, the cooling pathway 122 is an exterior pathway disposed not just radially outside the stator 18, as described above, but also radially outside the housing 20. It is permissible according to some aspects of the present invention, however, for the cooling pathway to instead be defined within the housing (e.g., if the shield were to extend into the interior chamber from an inner surface of the shell). Most preferably, however, the cooling pathway 122 is at least in part radially outside the stator 18.

The fan 110 and the housing 20 are cooperatively configured to direct or draw the air or other fluid from the commutator-receiving space 118 and through the stator-receiving space, then force the air or other fluid out the element-receiving space 120 and into the cooling pathway 122. More particularly, in a preferred embodiment and method of operation, heat is generated by the commutator assembly 24 during operation of the motor 12, warming the adjacent air. The fan 110 preferably draws this warm air from the commutator-receiving space 118 and then contemporaneously or at least substantially contemporaneously or simultaneously through each of the internal channels 80 between the field coils 70 (i.e., through the primary and secondary internal channels 80a and 80b, which are within the stator-receiving space 116), drawing additional heat from the field coils 70. The warmed air is then propelled out of the element-receiving space 120 into the cooling pathway 122. Thermal dissipation preferably occurs as the air travels along the cooling pathway 122 to reduce the temperature of the air. The cooled air is then drawn back into the commutator-receiving space 118, begins taking on heat, and the cycle repeats.

In a preferred embodiment, the field coils 70 are sized or spaced in such a manner as to enable effective flow of air through the internal channels 80a and 80b. That is, the channels 80a and 80b are sufficiently broad to enable effective drawing off of heat from the coils as the air flows therepast.

More particularly, each of the primary field coils 70a preferably presents a generally arcuate primary field coil span θₚᵣᵢₘₑ. Each of the primary internal channels 80a preferably presents a generally arcuate primary internal channel span Φₚᵣᵢₘₑ. The primary internal channel span Φₚᵣᵢₘₑ is preferably at least ten percent (10%) of the adjacent primary field coil spans θₚᵣᵢₘₑ. The primary internal channel Φₚᵣᵢₘₑ is more preferably at least fifteen percent (15%) of the adjacent primary field coil spans θₚᵣᵢₘₑ. The primary internal channel span Φₚᵣᵢₘₑ is most preferably about twenty percent (20%) of the adjacent primary field coil spans θₚᵣᵢₘₑ.

Similarly, each of the secondary field coils 70b preferably presents a generally arcuate secondary field coil span θ_{sec}. Each of the secondary internal channels 80b preferably presents a generally arcuate secondary internal channel span Φ_{sec}. The secondary internal channel span Φ_{sec} is preferably at least fifty percent (50%) of the adjacent secondary field coil spans θ_{sec}. The secondary internal channel span Φ_{sec} is more preferably at least seventy-five percent (75%) of the adjacent secondary field coil spans θ_{sec}. The secondary internal channel span Φ_{sec} is most preferably about one hundred twenty percent (120%) of the secondary primary field coil spans θ_{sec}.

In the illustrated embodiment, the primary field coil span θₚᵣᵢₘₑ is about seventy-five degrees (75), the primary internal channel span Φₚᵣᵢₘₑ is about fifteen degrees (15), the secondary field coil span θ_{sec} is about forty-one degrees (41), and the secondary internal channel span Φ_{sec} is about forty-nine degrees (49°).

Considering the collective field coils 70 and internal channels 80, it will be apparent from the above that a minimum internal channel Φₘᵢₙ (in the preferred embodiment, equivalent to the primary internal channel span Φₚᵣᵢₘₑ) is preferably at least ten percent (10%) of the adjacent maximum field coil spans θₘₐₓ (in the preferred embodiment, equivalent to the primary field coil spans θₚᵣᵢₘₑ). The minimum primary internal channel span Φₘᵢₙ is more preferably at least fifteen percent (15%) of the adjacent maximum field coil spans θₘₐₓ. The minimum internal channel span Φₘᵢₙ is most preferably about twenty percent (20%) of the adjacent maximum field coil spans θₘₐₓ.

It is particularly noted that the preferred relatively large internal channels and relatively small field coils are in contrast to those found in motors in which field coil size is maximized (and internal channels are minimized or effectively non-existent) to increase conductive thermal transfer from the field coils to the housing or frame. That is, the present invention emphasizes convective thermal transfer from the field coils to the internal channels, rather than conductive thermal transfer from the field coils to the housing.

Preferably, cooling of the air in the cooling pathway 122 is achieved via conduction through the shield 136 and convection from the shield 136 to the environment. Convection from the shield 136 to the environment is preferably aided by the aforementioned fans 104 of the secondary convective cooling system 100. That is, the shroud 102 preferably at least substantially encompasses or extends about (i.e., overlies in a spaced relationship) the shield 136 such that external or environmental air (and/or other gases) driven by the fans 104 are directed across the surface of the shield 136 to remove heat therefrom.

It is also permissible according to some aspects of the present invention for additional cooling elements or mechanisms (e.g., coolant coils or heat sink fins disposed in the flow path) to be provided in the cooling pathway 122 and/or in either of the commutator-receiving or element-receiving spaces 118 or 120, respectively.

In the preferred illustrated embodiment, the shield 136 and, in turn, the cooling pathway 122, are dimensioned to extend circumferentially around about one sixteenth ( 1/16) to about one fourth (¼) the diameter of the shell 30 and tube portion 132. More preferably, the shield 136 and the cooling pathway 122 extend circumferentially around about one eighth (⅛) the diameter of the shell 30 and tube portion 132. However, it is permissible according to some aspects of the present invention for the shield and cooling pathway to extend more or less fully about the shell and tube.

Yet further, the cooling pathway might in fact extend around the entirety of the housing. That is, rather than a shield defining a discrete cooling pathway, a fully circumferentially extending space might be provided (e.g., by provision of an oversized outer sleeve circumscribing the shell and tube).

It is particularly noted that, in a preferred embodiment, recirculation of the air through the internal channels 80 and the cooling pathway 122 occurs in an efficient and forceful manner. That is, the air may accurately be described as driven, pressurized, directed, and/or flowing. In other words, the air preferably is not simply “stirred up” or stagnant.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. An electric motor assembly comprising:
a housing;
a rotor rotatable about an axis;
a stator including a core and a plurality of coils wound about the core;
a commutator; and
a fluid-driving element configured to drive a fluid;
said housing defining an internal chamber including—
a stator-receiving space at least substantially receiving the stator,
a commutator-receiving space at least substantially receiving the commutator, and
an element-receiving space at least substantially receiving the fluid-driving element,
said housing further defining a cooling pathway fluidly interconnected with the internal motor chamber and disposed at least in part radially outside the stator,
said fluid-driving element and said housing cooperatively configured to direct said fluid through each of said stator-receiving space, said commutator-receiving space, said element-receiving space, and said cooling pathway.

2. The electric motor assembly of claim 1,
said fluid-driving element and said housing cooperatively configured to recirculate the fluid through the cooling pathway, the commutator-receiving space, the stator-receiving space, and the element-receiving space.

3. The electric motor assembly of claim 2,
said fluid-driving element and said housing cooperatively configured to recirculate the fluid sequentially through the cooling pathway, the commutator-receiving space, the stator-receiving space, and then the element-receiving space.

4. The electric motor assembly of claim 2,
said cooling pathway extending directly between and fluidly interconnecting said commutator-receiving space and said element-receiving space.

5. The electric motor assembly of claim 4,
said cooling pathway being at least substantially straight.

6. The electric motor assembly of claim 4,
said cooling pathway extending at least substantially axially and configured such that fluid flows therethrough in an at least substantially axial direction.

7. The electric motor assembly of claim 4,
said stator-receiving space being disposed axially between and fluidly interconnecting said commutator-receiving space and said element-receiving space.

8. The electric motor assembly of claim 2,
said stator-receiving space being disposed axially between and fluidly interconnecting said commutator-receiving space and said element-receiving space.

9. The electric motor assembly of claim 1,
said cooling pathway being disposed radially outside said stator-receiving space.

10. The electric motor assembly of claim 1,
said housing including a shell at least substantially defining the stator-receiving space and a shield fixed exteriorly to the shell,
said shield and said shell cooperatively defining the cooling pathway.

11. The electric motor assembly of claim 10, further comprising:
an exterior fan system,
said exterior fan system including a shroud and an external fan mounted on the shroud,
said shroud being fixed exteriorly to the shell and at least substantially extending about the shield such that the external fan is configured to direct external air across the shield.

12. The electric motor assembly of claim 1,
said cooling pathway circumscribing only a portion of the stator.

13. The electric motor assembly of claim 12,
said cooling pathway circumscribing about one eighth of the stator.

14. The electric motor assembly of claim 1,
each pair of adjacent coils defining an internal channel therebetween,
said fluid-driving element and said housing cooperatively configured to direct said fluid through each of the internal channels.

15. The electric motor assembly of claim 14,
said internal channels being evenly arcuately spaced apart.

16. The electric motor assembly of claim 14,
said motor assembly including four of said internal channels.

17. The electric motor assembly of claim 14,
said fluid-driving element and said housing cooperatively configured to recirculate the fluid sequentially through the cooling pathway, the commutator-receiving space, the internal channels in a substantially contemporaneous manner, and then the element-receiving space.

18. The electric motor assembly of claim 14,
each of said coils presenting a generally arcuate coil span,
each of said internal channels presenting a generally arcuate channel span,
each channel span being at least 10% of the adjacent coil spans.

19. The electric motor assembly of claim 18,
each of said coils presenting a generally arcuate maximum coil span,
each of said internal channels presenting a generally arcuate minimum channel span,
each minimum channel span being about 20% or more of the adjacent maximum coil spans.

20. The electric motor assembly of claim 1,
said fluid-driving element comprising a fan.

21. The electric motor assembly of claim 21,
said fan being a centrifugal fan fixed to the rotor.
